(19) United States
(12) Patent Application Publication
(10) Pub. No.: US 2020/0090822 A1
(43) Pub. Date: Mar. 19, 2020

(54) Method for Enhanced Nuclear Reactions

(71) Applicant: Shui Yin Lo, Arcadia, CA (US)

(72) Inventor: Shui Yin Lo, Arcadia, CA (US)

(21) Appl. No.: 16/361,798

(22) Filed: Mar. 22, 2019

Related U.S. Application Data
(60) Provisional application No. 62/648,566, filed on Mar. 27, 2018.

(51) Int. Cl. G21B 3/00; G21G 1/00; G21G 1/02

(52) U.S. Cl. CPC G21B 3/006; G21G 2001/0094; G21G 1/02; G21G 1/001

(57) ABSTRACT

A method for enhanced nuclear reactions includes the steps of providing a first target which is a thin film with solid deuterium; providing a deuteron beam having an extreme ultraviolet laser and a first infrared laser to apply on the first target to ionize the deuterium to form positive charged deuterons and electrons; providing a second infrared laser to the first target to accelerate the electrons and the positively charged deuterons; separating the accelerated electrons and the accelerated positively charged deuterons under a magnetic field; providing the accelerated electrons to move in a circular motion and the accelerated positive charger deuterons to move to form a cluster of accelerated positively charged deuterons, and breaking the cluster of accelerated positive charged deuterons into small pieces of positively charged deuterons.

### CROSS-REFERENCE TO RELATED APPLICATIONS

The application claims the benefit of a U.S. provisional application No. 62/648,566 filed on Mar. 27, 2018 and entitled “Method and Apparatus of Construction of Greatly Enhanced Coherent Nuclear Fusion Device” which provisional application is incorporated by reference herein in its entirety.

### FIELD OF THE INVENTION

The present invention generally relates to a method for nuclear reaction, and especially to a nuclear reaction utilizing an enhancing laser mechanism to separate the electrons and deuterons in an accelerating deuteron beam, wherein the method comprises coherent nuclear fusion reactions, which have bosons in their final states.

### BACKGROUND OF THE INVENTION

Those skilled in the art will recognize that nuclear fusion provides low-cost generation of electricity without environmental pollution. In nuclear fusion, a huge amount of energy is released when light nuclei (for example, deuterium and tritium) are combined into a relatively heavy nucleus (for example, helium). Nuclear fusion refers to a nuclear reaction form in which a nucleus aggregation effect takes place. Such a reaction needs certain conditions, such as super high temperature and pressure, in order to generate a new nucleus of a bigger mass from atoms of smaller lower masses (mainly deuterium or tritium), along with a release of a huge amount of energy.

Most of the effort has been in magnetic confinement of hot plasma above 100 million degrees (12.5 keV) in the last sixty years. There has been huge progress. The most promising one is ITER in France funded by an international effort. The annual budget is more than a billion dollars. But it still decades in the future before it is commercially useful.

Hence last year there is an attempt to create accelerator-based fusion reactor by Liu and Chao. (Accelerator based fusion reactor, Keh-Fei Liu and Alexander Wu Chao, Nucl. Fusion 57 (2017) 084002, 7pp). They considered a beam of deuterons from the accelerator which is applied to hit the target plasma of a mixture of deuterium-tritium on the resonance of the fusion reaction. The energy of deuteron-deuteron that nuclear fusion needs to come from the beam rather from the kinetic energy of the hot plasma as in ITER.

In this manner, the temperature of the hot plasma is not determined by the nuclear interaction. The critical temperature of the plasma is determined from overcoming the stopping power of the beam with the fusion energy gain. The needed plasma lifetime is determined from the width of the resonance, the beam velocity, and the plasma density. The temperature of hot plasma that they consider is much cooler than ITER, but still of millions degree.

### BRIEF SUMMARY OF THE DISCLOSURE

In a general implementation, a method for enhanced nuclear reactions comprises the steps of: providing a first target which is a thin film with solid deuterium; providing a deuteron beam having an extreme ultraviolet laser and a first infrared laser to apply on the first target to ionize the deuterium to form positive charged deuterons and electrons; providing a second infrared laser to the first target to accelerate the electrons and the positively charged deuterons; separating the accelerated electrons and the accelerated positively charged deuterons under a magnetic field; providing the accelerated electrons to move in a circular motion and the accelerated positive charger deuterons to move to form a cluster of accelerated positively charged deuterons; and breaking the cluster of accelerated positive charged deuterons into small pieces of positively charged deuterons.

In another aspect combinable with the general implementation, at least one of the first target is selected from a group consisting of lithium 7 and boron 11.

In another aspect combinable with the general implementation, wherein the nuclear reaction is a deuteron-deuterons reaction.

In another aspect combinable with the general implementation, wherein the nuclear reaction is selected from a group consisting of proton-lithium 7 reaction, proton-boron reaction, and helium 3 and lithium 6 reactions.

In another aspect combinable with the general implementation, the nuclear reactions generate coherent final α particles and photons in deuteron-deuterons reactions.

In another aspect combinable with the general implementation, wherein the nuclear reactions generate two coherent final α particles and photons in proton-lithium 7, and helium 3 and lithium 6 reactions.

In another aspect combinable with the general implementation, wherein the number density of the deuterons in solid deuterium is 5.92×10²⁸/m3, and the distance between each of the deuterons is 0.256 nm.

In another aspect combinable with the general implementation, wherein, the nuclear reactions generate three coherent final α particles in proton-boron reaction.

In another aspect combinable with the general implementation, the method for the enhanced nuclear reaction further comprises the step of providing a second target where the accelerated positively charged deuterons to be reached.

In another aspect combinable with the general implementation, wherein total energy of the extreme ultraviolet laser and a first infrared laser is equal to the ionization energy of deuterium.

In another aspect combinable with the general implementation, wherein the accelerated electrons move forward at a greater speed than the accelerated positively charged deuterons to separate the accelerated electrons and accelerated positively charged deuterons.

In another aspect combinable with the general implementation, wherein the magnetic field is imposed in the vertical direction.

In another aspect combinable with the general implementation, wherein the method for enhanced nuclear reaction further comprises a step of providing an iron shield to shield the magnetic field to reach the first target so as to prevent the interference between the first target and the second target.

In another aspect combinable with the general implementation, wherein a strength of the magnetic field is from 100-kilogauss to 200-kilogauss

In another aspect combinable with the general implementation, wherein the method for enhanced nuclear reaction further comprises a step of forming a gap between the first target and the second target.

In another aspect combinable with the general implementation, wherein a distance of the gap is 100 nm.

In another aspect combinable with the general implementation, wherein the extreme ultraviolet laser is selected from a group consisting of Ar2* excimer lasers, Kr2* excimer lasers, F2* excimer lasers, Xe2* excimer lasers, and ArF excimer lasers.

In another aspect combinable with the general implementation, wherein a wavelength of the extreme ultraviolet laser is 121.6 nm.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub combination. Moreover, although features may be described above and below as acting in certain combinations and even initially claimed as such, one or more features from a claimed combination can in some cases be excised from the combination, and the claimed combination may be directed to a sub combination or variation of a sub combination.

A number of implementations have been described. Nevertheless, it will be understood that various modifications may be made without departing from the spirit and scope of the disclosure. For example, example operations, methods, or processes described herein may include more steps or fewer steps than those described. Further, the steps in such example operations, methods, or processes may be performed in different successions than that described or illustrated in the figures. Accordingly, other implementations are within the scope of the following claims.

The details of one or more implementations of the subject matter described in this disclosure are set forth in the accompanying drawings and the description below. Other features, aspects, and advantages of the subject matter will become apparent from the description, the drawings, and the claims.

### BRIEF DESCRIPTION OF THE DRAWINGS

It should be noted that the drawing figures may be in simplified form and might not be to precise scale. In reference to the disclosure herein, for purposes of convenience and clarity only, directional terms such as top, bottom, left, right, up, down, over, above, below, beneath, rear, front, distal, and proximal are used with respect to the accompanying drawings. Such directional terms should not be construed to limit the scope of the embodiment in any manner.

FIG. 1 is a block diagram of a method for enhanced nuclear reactions according to a preferred embodiment of the present invention.

FIG. 2 is a schematic view of a method for the enhanced nuclear reaction according to the above mentioned preferred embodiment.

FIG. 3A and FIG. 3B are schematic views of the deuterium, illustrating the movement of the accelerated electrons and the accelerated positively charged deuterons.

FIG. 4A and FIG. 4B are schematic views of the accelerated electrons and the accelerated positively charged deuterons, illustrating a cluster of the accelerated positively charged deuterons being breaking into small pieces.

### DETAILED DESCRIPTION OF THE INVENTION

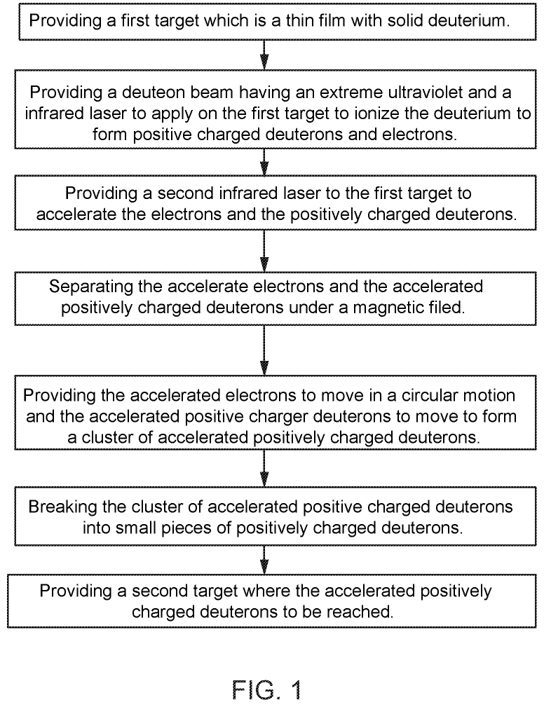

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “first,” “second,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

At the outset, it should be clearly understood that like reference numerals are intended to identify the same structural elements, portions, or surfaces consistently throughout the several drawing figures, as may be further described or explained by the entire written specification of which this detailed description is an integral part. The drawings are intended to be read together with the specification and are to be construed as a portion of the entire “written description” of this invention as required by 35 U.S.C. § 112.

FIG. 1 generally depicts the block diagram of a method for enhanced nuclear reactions in accordance with one of the disclosed embodiment. The method for the enhanced nuclear reactions comprises the following steps:

providing a first target 101 which is a thin film with solid deuterium 200;

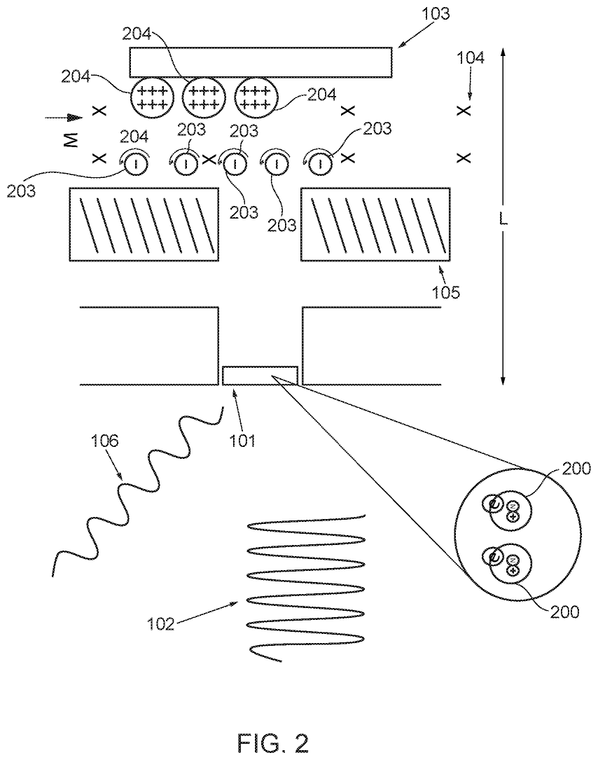

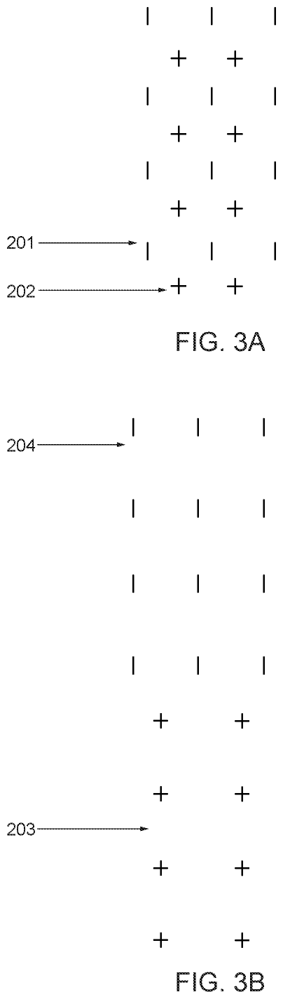

providing a beam 106 of an extreme ultraviolet laser and a first infrared laser to apply on the first target to ionize the deuterium 200 in the first target to form positively charged deuterons 202 and electrons 201, as shown in FIG. 2 and FIG. 3;

providing a second infrared laser 102 to the first target to accelerate the electrons 201 and the positively charged deuterons 202;

separating the accelerated electrons 203 and the accelerated positively charged deuterons 203 under a magnetic field M;

providing the accelerated electrons 203 to move in a circular motion and the accelerated positive charger deuterons 204 to move to form a cluster of accelerated positively charged deuterons 203; and

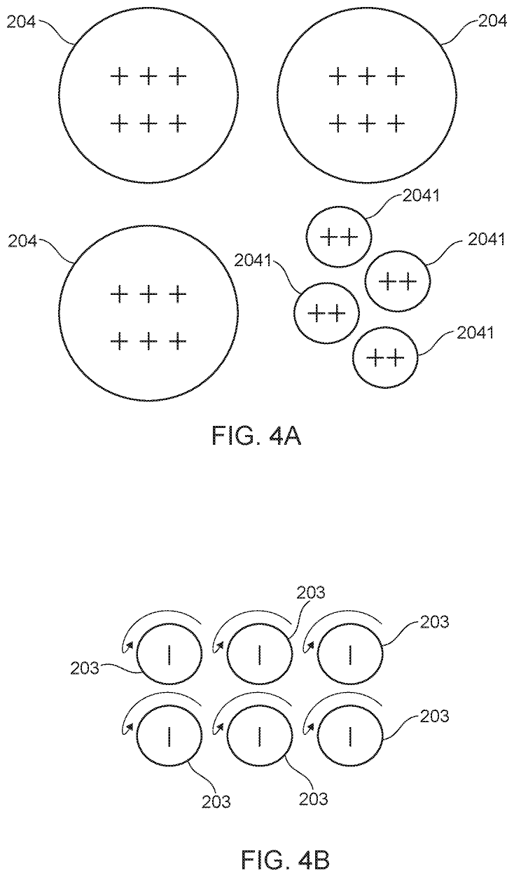

breaking the cluster of accelerated positive charged deuterons 204 into small pieces of positively charged deuterons 2041, as shown in FIG. 4.

Accordingly, the method for enhanced nuclear reactions is a deuteron-deuterons reaction, wherein the equation of the enhanced nuclear reaction is:

deuteron d(l)+deuteron d(k)→alpha α(p)+photon γ(q),

The deuterons d (l) are in the deuteron beam with kinetic energy of 100 KeV, and the deuterons d (k) are in the first target, and then produces alpha particles, coherent α(p) and coherent photon γ(q), where l, k, p, q denote the momenta of deuteron, target deuterons, alpha particles, and photons. In other words, the alpha particles α(p) is the nucleus of helium ⁴He. The nuclear energy released is 23.84 MeV. It is worth mentioning that the total energy of the deuteron beam 106 including extreme ultraviolet laser and a first infrared laser is equal to the ionization energy of deuterium 200.

In one aspect, the accelerated electrons 203 move forward at a greater speed than the accelerated positively charged deuterons 204 to separate the accelerated electrons 203 and the accelerated positively charged deuterons 204.

In another aspect, as shown in FIGS. 1 and 3, the accelerated electrons 203 move around in tiny circles and never reach the second target 103. The deuterons 204 can move forward toward the second target 103. Because of the strong repulse Coulomb force, the accelerated positively charged deuterons 204 may repel one another, wherein the deuterons 204 would only bend slightly and be able to hit the second targets 103 without the electrons 203. As shown in FIG. 4, the original one quantum state of all deuterons 204 in the second target can be broken by the many smaller pieces of deuterons 2041. The deuterons 2041 are in each small pieces in one quantum state. It is similar to a glass break into many small pieces of glass.

In one embodiment, a cluster of deuteron beams 106 can be applied to hit the first target 101 to generate a coherent nuclear fusion reaction. The equation of the coherent nuclear fusion reactions is shown as below.

d(l₁)+d(l₂)+ . . . d(lₘ)+d(k₁)+d(k₂) . . . +d(kₘ)→mα(p)+mγ(q)

Accordingly, a cluster of deuteron beams 106 can be hit on a cluster of deuterium 200 to generate photons γ and alpha particles α.

In one aspect, the number density of the deuterons 204 in solid deuterium 200 is 5.92×10²⁸/m3, and the distance between each of the deuterons is 0.256 nm.

Accordingly, the electrons 203 are fully detached from individual deuterium 200 and can flow freely around the deuterons 204. Then a second infrared laser 102 comes and hits the fully ionized first target 101, and separate the group of electrons 203 from the group of deuterons 204 under a magnetic field M, wherein the magnetic field M is perpendicular to the motion of electrons 203 and deuterons 204. In another word, the magnetic field M is imposed in the vertical direction, wherein the group of deuterons 204 can be accelerated by the magnetic field—M, which comprise kinetic energy (100 keV-200 keV).

In another embodiment, the first target 101 can be selected from a group consisting of lithium 7 and boron 11. In other words, the nuclear reaction is selected from a group consisting of proton-lithium 7 reaction, proton-boron reaction, and helium 3 and lithium 6 reactions.

Accordingly, in one aspect, the equation of the proton-lithium 7 reaction is shown below:

¹H+⁷Li→2⁴He

Accordingly, the proton-lithium 7 reaction generates two coherent final α particles and photons.

In another aspect, the equation of the proton-boron reaction is shown below:

P+¹¹B→3⁴ He

Accordingly, the proton-boron reaction generates three coherent final α particles and photons, wherein the symbol ¹¹B can be used as a boron atom and boron nucleus. The nuclear energy released is 8.7 MeV.

In yet another aspect, the equation of the Helium 3 and Lithium 6 reaction is shown below:

³He+⁶ Li→2⁴He+p

Accordingly, the Helium 3 and Lithium 6 reaction generates two coherent final α particles and photons.

The method for enhanced nuclear reactions further comprises the following steps:

a step of providing a second target 103 where the accelerated positively charged deuterons 204 to be reached;

providing an iron shield 105 to shield the magnetic field M to reach the first target 104 so as to prevent the interference between the first target 101 and the second target 103; and

forming a gap between the first target 101 and the second target 103.

In one aspect, the gap distance between the first target 101 and the second target 103 must be kept short in the range of centimeter, so that the accelerated positively charged deuterons 204 will remain in one quantum state, or in groups of deuterons, each of which is in one quantum state. Optimally, a distance of the gap is 100 nm.

In yet another embodiment, the extreme ultraviolet laser in the deuteron beam 106 is modified from a group consisting of Ar2* excimer lasers, Kr2* excimer lasers, F2* excimer lasers, Xe2* excimer lasers, and ArF excimer lasers, wherein the wavelength of the Ar2* excimer laser is 126 nm, and the wavelength of the Kr2*excimer laser is 146 nm), and the wavelength of the F2* excimer laser is 157 nm, and the wavelength of the excimer laser Xe2* is 172 nm, and the wavelength of the F2* excimer laser is 175 nm, and the wavelength of the ArF excimer laser is 193 nm.

Optimally, the wavelength of the extreme ultraviolet laser is 121.6 nm.

In still yet another aspect, the deuteron beam 106 comprises an extreme ultraviolet laser with 10.2 eV of photon energy, and three infrared lasers with photon energies of 1.5 eV, 1.9 eV, and 1.8 eV to ionize the deuterium molecules into deuterons and almost free electrons.

Accordingly, the result of the enhanced nuclear reactions of the present invention can be stated in a simple rule: “When there are m coherent boson is the final state, the reaction rate is increased by a factor m.” When there are two types of coherent bosons, each of which has m bosons, the reaction rate is increased by a factor m².” “When there are three types of coherent bosons, each of which m bosons, the reaction rate is increased by a factor m³.

So the equation of d+d→α+γ, the enhancement factor is m², where m is the number of coherent α and γ in the final state. For p+¹¹B→3α, the enhancement factor is m³.

When we are considering practical nuclear fusion, the number m of nuclear fusion reaction at one time is of the order 10¹², or more. But because of the enhancement of nuclear reaction rate by coherence the enhancement factor m could be a much smaller number: thousands for p+¹¹B→3α to a hundred thousand od the equation of d+d→α+γ

Enhancement of Reaction Rate from Coherence of Bosons Participate in the Nuclear Fusion Reaction

The present invention relies on the large enhancement from the coherence of bosons that participate in the nuclear fusion reaction. Approximately with m particle of one coherent boson, the enhancement is by a factor m. With two kinds of coherent bosons, each with m particle, the enhancement is by a factor m².

The enhancement of coherent photons, which is bosons, in a laser is well known and widely used. We hereby extend the enhancement mechanism for the laser to bosons involved in nuclear fusion reactions.

The present invention utilizes two targets, two sets of laser and high electric voltage to achieve nuclear fusion. The first set of lasers have the right energy to separate the molecular deuterium into deuterium atoms, and in turn, get ionized by an extreme ultraviolet laser and two infrared lasers so that the electrons attached to deuterons nuclei become detached. The electrons will flow together as a group, interact as a group to the ultrashort laser, get accelerated and become separate from the deuterons. The deuterons as a group also will interact with the ultrashort laser and get accelerated. The photons from the ultrashort pulse will interact with charges of particles regardless of their charges. So the group of electrons should get the same amount of energy as the group of deuterons from the ultrashort pulse coherent photons. As the mass of deuterons M is 2 GeV, and the mass of electron m is 0.5 MeV, we have

½v_{D}²=½mvₑ²

where v_{d} and vₑ are the velocities of deuterons and electrons. The electron velocity is much larger (M/m)^{1/2} about 4000^{1/2}, or 63 times larger.

Under the magnetic field B, the electrons will turn in circle with radius r, and the deuteron will turn in circle with radius R:

r/R=(m/M)^{1/2}=1/63.

For B=0.1 T and kinetic energy of 1 keV, the radius for an electron is 1 mm, very small circle, and the radius of the accelerated positively charged deuterons 204 is 6.47 cm. So the accelerated electrons 203 would not reach the second target 103. And the accelerated positively charged deuterons 204 are bent slightly and will strike the second target to cause nuclear fusion.

Extreme Ultraviolet Laser

It is possible to develop an extreme ultraviolet laser along more convention lasers. Let us take the case of the deuterium atom. The lowest level is n=1 K shell, with energy E₁=−13.6 eV.

The excited levels are n=2 M shell, with energy E₂, n=3, N shell with energy E₃:

En=E₁/n²

To raise the deuterium atom to its electron from K-shell to M-shell the photon energy is

hω₁/2π=E₂−E₁

=E₁(1/2²−1/1)

=10.2 eV.

To raise the electron from M-shell n=2 to N shell n=3, the photon energy is

hω₂/2π

=E₃−E₂

=E₁(1/3²−1/2²)

=1.9 eV

To raise the electron form N shell to ionization state is

hω₃/2π=E₁(1/∞−1/3²)

=1.5 eV.

The ionization energy of deuterium molecule is 15.4 eV, and the ionization energy of deuterium is 13.6 eV. So there is a need for a photon with the energy 1.8 eV to dissociate deuterium molecules into deuterium atom.

So we need an extreme ultraviolet laser, with photon energy 10.2 eV, and three infrared lasers with photon energies of 1.5 eV, 1.9 eV, 1.8 eV to ionize the deuterium molecules into deuterons plus electrons.

It is possible to create an extreme ultraviolet laser with the exact energy 10.2 eV (wavelength 121.6 nm). A gas laser with the principal gas of deuterium with mirrors made up of SiC could be constructed. Excimer lasers have been constructed that can lase at ultraviolet vacuum region below wavelength 200 nm is Ar₂*(126 nm), Kr₂*(146 nm), F₂*(157 nm). Xe₂*(172 nm, 175 nm), and ArF (193 nm).

It is significant to note that Ar₂* excimer lasers at 126 nm, which is very close our required wavelength of 121.6 nm. The development for a new Extreme ultraviolet laser with the lasing medium of deuterium gas and not Argon gas at 121.6 nm is expected to have a little difficult because most of the electric circuit an optical system for Ar₂* excimer may be adopted with only minor modification.

From Gigaphoton (hitp://www.gigaphoton.com) there is an industrial excimer GT61A, which has wavelength 193 nm, average output 60 W, and repetition rate 6,000 Hz. Another two lasers with photons energies 1.9 eV (wavelength 652 nm) and 1.5 eV (827 nm) are needed to raise the energy of the electrons in deuterium to just ionized state at room temperature. Commercially there are available tunable dye lasers that can satisfy our requirement.

The laser company NKT Photonics has a model Fianium White Laser Supercontinuum Lasers that provides a broadband single-mode output in the entire 400-2400 nm range. This laser has the following features:
400-2400 nm continuous output
MHz repetition rate range, with picosecond pulses
Highest available output power up to 20 W.”

Ultrashort Pulse Laser
From AMPHOS INC., its laser has the following features:
Pulse duration: 800 fs; repetition rate 10 kHz
Pulse energy 50mJ
Wavelength 1030 nm
Power of the laser=500 watt

From the company's information, it seems the company can adjust the parameters of their AMOHOS laser to suit our need.

The size of the ultrashort pulse laser from AMOPHOS is small. Its dimensions are less than one meter.

For our purpose, AMPHOS lasers do not have the particular features we want.

The ultrashort pulse laser that we need for coherent nuclear fusion should have the following features:
Average power P_{γ}=500 watt
The energy of each ultrashort pulse is 5 Joule
The repetition rate is 100 Hz
The number of photons in each pulse is n_{γ}=3.12×10¹⁹
The number of deuterons accelerated to kinetic energy K_{d} is K_{d}=100 eV And n_{d}=3.12×10¹⁶ per pulse

The inefficiency of factor 10 will require 10³ photons to create one energetic deuteron moving with kinetic energy 100 eV.

The number of deuterons with 100 eV in one second: N_{d}=3.12×10¹⁸/sec

The number of deuterons with 100 eV in one second: N_{d}=3.12×10¹⁸/sec

The fusion energy released in one second E_{f}=N_{d} Q=11.9 MW. It is enough power for a small nuclear fusion electric power station.

The ratio of output energy of the nuclear fusion with the input energy to the system is E_{f}/(photon energy+accelerating energy),

The acceleration energy in one second is Eₐ=(N_{d}+×100 keV

Where Ne is the number of ionized electrons, which is equal to the number of deuterons in target 1. Eₐ=9.98×10⁴ Joule in one second.

Let us be generous, and acceleration energy is twice as calculated above. Then the acceleration energy is 2×10⁵ joule in one second

The gentle ionization energy for electrons and deuterons is Eᵢ=N_{d}×13.6 eV=6.78 Joule in one second, which is negligible.

The photon energy from the ultrashort laser is 500 watt, which is also negligible compared with the energy in acceleration:

The ratio r is r=11.9 MW/2×10⁵=60

Size of Target 1:

The volume of deuterium participating in becoming fully gentle ionized plasma is V=n_{d}/density of the deuterium=3.12×10¹⁶/5×10²²=6.24×10⁻⁷ cm⁻³

It the effective target size is 100 um thick, and area 80 nu×80 um, the effective volume is 6.4×10⁻⁷ cm³

The intensity of photon incident on target 1 is Intensity=5 J/(duration of the pulse×area)=10¹⁷ w/cm², which is high enough to ionize separate, and accelerate.

Summary of Major Element of Coherent Nuclear Fusion

a. Enhancement due to coherence: The increase of reaction rate is by a factor of m, m being the number of the coherent particles. For d+d→α+γ, the enhancement factor is m², which is much larger than the other two reactions d+d→³ He+n, t+p. In the equation of d+d→3α, the enhancement factor is m³

b. Hypothesis: gentle ionization of solid deuterium (or solid hydrogen) by extreme ultraviolet laser and infrared lasers to separate deuterons (protons) from electrons. The deuterons (or protons) remain in one quantum state.

c. Separation of deuterons (or protons) from electrons by ultrashort pulse laser, wherein deuterons (or protons) break down into many quantum states.

d. Acceleration to 100 keV from a normal high voltage supply, which is a very efficient method.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What I claim is:

1. A method for enhanced nuclear reactions, comprising the steps of:
providing a first target which is a thin film with solid deuterium;
providing an extreme ultraviolet laser and first infrared lasers to apply on the first target to ionize the deuterium to form positive charged deuterons and electrons;
providing a second infrared laser to the first target to accelerate the electrons and the positively charged deuterons;
separating the accelerated electrons and the accelerated positively charged deuterons under a magnetic field;
providing the accelerated electrons to move in a circular motion and the accelerated positive charger deuterons to move to form a cluster of accelerated positively charged deuterons; and
breaking the cluster of accelerated positive charged deuterons into small pieces of positively charged deuterons.

2. The method for enhanced nuclear reactions, as recited in claim 1, wherein the first target is selected from a group consisting of lithium 7 and boron 11.

3. The method for enhanced nuclear reactions, as recited in claim 1, wherein the nuclear reaction is a deuteron-deuterons reaction.

4. The method for enhanced nuclear reactions, as recited in claim 2, wherein the nuclear reaction is selected from a group consisting of proton-lithium 7 reaction, proton-boron reaction, and helium 3 and lithium 6 reactions.

5. The method for enhanced nuclear reactions, as recited in claim 3, wherein, the nuclear reaction generates two coherent final α particles and photons in deuteron-deuterons reaction.

6. The method for enhanced nuclear reactions, as recited in claim 4, wherein, the nuclear reaction generates two coherent final α particles and photons in proton-lithium 7, and helium 3 and lithium 6 reactions.

7. The method for enhanced nuclear reactions, as recited in claim 3, wherein the number density of the deuterons in solid deuterium is approximately 5.92×10²⁸/m3, and the distance between deuterons is approximately 0.256 nm.

8. The method for enhanced nuclear reactions, as recited in claim 4, wherein, the nuclear reactions generate three coherent final α particles in proton-boron reaction.

9. The method for enhanced nuclear reactions, as recited in claim 3, further comprising the step of providing a second target where the accelerated positively charged deuterons to be reached.

10. The method for enhanced nuclear reactions, as recited in claim 9, wherein total energy of the extreme ultraviolet laser and first infrared lasers is equal to the ionization energy of deuterium.

11. The method for enhanced reactions, as recited in claim 10, wherein the accelerated electrons move forward at a greater speed than the accelerated positively charged deuterons to separate the accelerated electrons and accelerated positively charged deuterons.

12. The method for enhanced nuclear reactions, as recited in claim 11, wherein the magnetic field is imposed in the vertical direction.

13. The method for enhanced nuclear reactions, as recited in claim 12, further comprising a step of providing an iron shield to shield the magnetic field to reach the first target so as to prevent the interference between the first target and the second target.

14. The method for enhanced nuclear reactions, as recited in claim 13, wherein a strength of the magnetic field is from 100-kilogauss to 200-kilogauss.

15. The method for enhanced nuclear reactions, as recited in claim 14, further comprising a step of forming a gap between the first target and the second target.

16. The method for enhanced nuclear reactions, as recited in claim 15, wherein a distance of the gap is approximately 100 nm.

17. The method for enhanced nuclear reactions, recited in claim 16, wherein the extreme ultraviolet laser is created from modifying one of the lasers from a group consisting of Ar2* excimer lasers, Kr2* excimer lasers, F2* excimer lasers, Xe2* excimer lasers, and ArF excimer lasers.

18. The method for enhanced nuclear reactions, as recited in claim 17, wherein a wavelength of the extreme ultraviolet laser is 121.6 nm.
